(19) United States
(12) Patent Application Publication
(10) Pub. No.: US 2008/0086587 A1
(43) Pub. Date: Apr. 10, 2008

(54) DATA SAVE APPARATUS AND DATA SAVE METHOD

(76) Inventors: Munetoshi EGUCHI, Tokyo (JP); Tomohiro Suzuki, Tokyo (JP); Yuji Tamura, Tokyo (JP); Tetsuya Ishikawa, Tokyo (JP); Hiroyasu Nishimura, Tokyo (JP); Tomoya Ogawa, Tokyo (JP); Fumikage Uchida, Tokyo (JP); Nao Moromizato, Tokyo (JP); Kenji Okuyama, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/868,199

(22) Filed: Oct. 5, 2007

(30) Foreign Application Priority Data
Oct. 10, 2006 (JP) JP2006-275991

(51) Int. Cl. G06F 12/00

(52) U.S. Cl. 711/102; 711/E12.002

(57) ABSTRACT

A data save apparatus including: a system memory, in which a plurality of segment regions having uneven capacities are provided; a nonvolatile memory, into which data having been memorized in the system memory are saved; and a controller which controls to save data with a unit of each of the segment regions into the nonvolatile memory from the system memory, wherein the controller determines whether saving data of each of the segment regions into the nonvolatile memory is necessary, and when a total capacity of segment regions, data in which having been determined to be necessary to be saved, reaches to a prescribed value, the controller transfers the data of the segment regions determined to be necessary to be saved into the nonvolatile memory by a DMA (Direct Memory Access) mode in descending order of segment region capacity.

### CROSS REFERENCE TO RELATED APPLICATION

The present application is based on Japanese Patent Application No. 2006-275991 filed with Japanese Patent Office on Oct. 10, 2006, the entire content of which is hereby incorporated by reference.

### BACKGROUND OF THE INVENTION

1. Field of Technology

This invention relates to a data save apparatus and a data save method for saving data from a system memory to a nonvolatile memory.

2. Description of Related Art

In an information processing apparatus which saves data from a volatile memory, such as a system memory, to a non-volatile memory when power is turned off, it is necessary to save data in a short time period before the output voltage of DC power supply decreases and reaches to a prescribed voltage after detecting the interruption of power supply. In cases where data amount to be saved is large, there may be a case that the save process cannot be completed in time.

Unexamined Japanese Patent Application Publication No H6-259339 (JPA6-259339) discloses a technique for controlling a volatile memory by diving the volatile memory into a plurality of blocks having the same capacity, and at the same, time providing to each blocks the updated flag for indicating that a processor has updated data but has not completed a data save process to a nonvolatile memory. The processor automatically saves the data in the updated block into nonvolatile memory when the number of the updated blocks, on which the updated flags are provided, become more than a specified number “n” so as to keep the total number of the updated blocks is equal to or less than the specified number “n”. According to this technique, the data amount to be saved when power is turned off can be controlled equal to or less than “n” blocks.

According to the technique disclosed in JPA6-259339, it is assumed that the respective blocks have the same capacity. However, since in many real cases, the size of information is different from each other, it is preferable that the capacity of each block is set based on the size of the information to be saved. As described above, when the capacities of respective blocks are uneven, and the save timing is determined based on only comparison of the number of updated blocks with the specified number “n”, following problems will occur.

For example, only blocks having large capacity are updated and in cases when the number of blocks to be updated is equal to or less than “n”, the save process is not commenced. However, in cases when the only blocks having large capacity have been update, the total capacity of updated blocks becomes larger than the capacity, which cannot be saved when power is turned off, and there may be a case that the save process cannot be completed.

Further, in the technique disclosed in JPA6-259339, a parallel process including a processor system process and a save system process is prohibited and priority is given to the processor system process to prevent the saved data from being mismatched. Thus the processor cannot execute the save system process with the blocks even where the processor is not accessing. Accordingly, the data save has not been efficiently conducted.

Therefore, an object of the present invention is to solve the foregoing problems, and to provide a data save apparatus and a data save method, which can control the data capacity to be saved to a nonvolatile memory from a system memory equal to or less than data capacity, which can be saved at the time of the power turning off, even though the capacities of divided areas provided in the system memory are uneven.

### SUMMARY

A data save apparatus reflecting one aspect of the present invention to achieve the foregoing object includes:

a system memory, in which a plurality of segment regions having uneven capacities are provided;

a nonvolatile memory, into which data having been memorized in the system memory are saved; and

a controller which controls to save data with a unit of each of the segment regions into the nonvolatile memory from the system memory,

wherein the controller determines whether saving data of each of the segment regions into the nonvolatile memory is necessary, and when a total capacity of segment regions, data in which having been determined to be necessary to be saved, reaches to a prescribed value, the controller transfers the data of the segment regions determined to be necessary to be saved into the nonvolatile memory by a DMA (Direct Memory Access) mode in descending order of segment region capacity.

A data save apparatus reflecting the aspect of the invention includes:

a system memory, in which a plurality of segment regions having uneven capacities are provided;

a nonvolatile memory, into which data having been memorized in the system memory are saved; and

a controller which controls to save data with a unit of each of the segment regions into the nonvolatile memory from the system memory,

wherein the controller determines whether saving data of each of the segment regions into the nonvolatile memory is necessary, and when a total capacity of segment regions, data in which having been determined to be necessary to be saved, reaches to a prescribed value, the controller transfers the data of the segment regions determined to be necessary to be saved into the nonvolatile memory by a DMA (Direct Memory Access) mode in ascending order of segment region capacity.

A data save method reflecting one aspect of the present invention is a method for saving data from a system memory, which includes a plurality of segment regions having uneven capacities, into a nonvolatile memory, with a unit of each of the segment regions, the method includes the steps of:

determining whether saving data of each of the segment regions into the nonvolatile memory is necessary; and transferring the data of the segment regions determined to be necessary to be saved into the nonvolatile memory by a DMA (Direct Memory Access) mode in descending order of segment region capacity, when a total capacity of segment regions, data in which having been determined to be necessary to be saved, reaches to a prescribed value.

A data save method reflecting another aspect of the present invention is a method for saving data from a system memory, which includes a plurality of segment regions having uneven capacities, into a nonvolatile memory, with a unit of each of the segment regions, the method includes the steps of:

determining whether saving data of each of the segment regions into the nonvolatile memory is necessary; and transferring the data of the segment regions determined to be necessary to be saved into the nonvolatile memory by a DMA (Direct Memory Access) mode in ascending order of segment region capacity, when a total capacity of segment regions, data in which having been determined to be necessary to be saved, reaches to a prescribed value.

### BRIEF DESCRIPTION OF THE DRAWINGS

These and other objects, advantages and features of the invention will become apparent from the following description thereof taken in conjunction with the accompanying drawings in which:

FIG. 1 illustrates a block diagram showing an image forming apparatus, to which a data save apparatus (a nonvolatile controller) related to an embodiment of the present invention has been applied;

FIGS. 2(a)-2(b) illustrate explanation drawings for exemplifying data expansion when power of the image forming apparatus related to an embodiment of the present invention is turned on, data save when the power is turned off and configurations of segment regions;

FIG. 3 illustrates a block diagram showing an inside configuration of a nonvolatile controller related to an embodiment of the present invention;

FIG. 4 illustrates a flowchart of a data update process conducted by the image forming apparatus related to an embodiment of the present invention;

FIG. 5 illustrates the flowchart of the data save process conducted by the nonvolatile controller related to an embodiment of the present invention; and

FIG. 6 illustrates the flowchart of the data save process at power being tuned off, conducted by the nonvolatile controller related to an embodiment of the present invention.

### DETAILED DESCRIPTION OF THE PREFERRED EMBODIMENT

An embodiment of the present invention will be described by referring to drawings hereinafter.

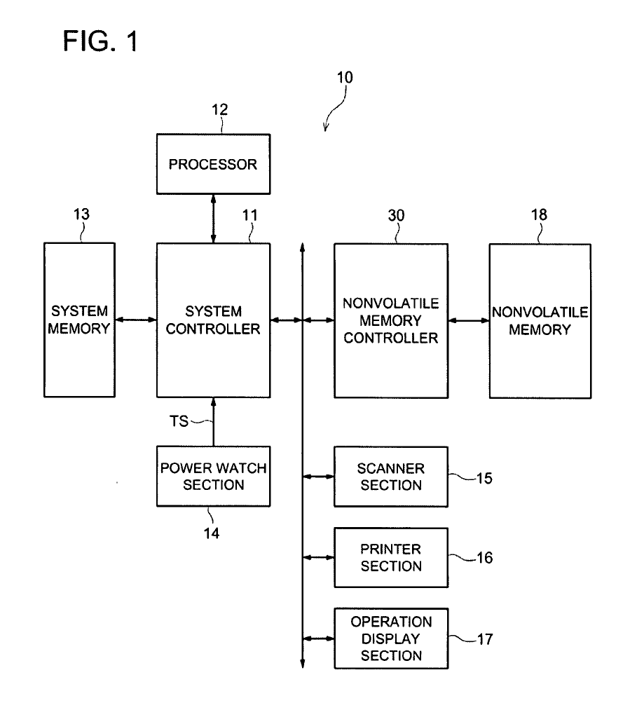

FIG. 1 illustrates a block diagram showing an image forming apparatus 10 including a data save apparatus pertaining to an embodiment of the present invention. The image forming apparatus 10 is a digital copier having a copy function for reading out a document image, forming a copied image onto a recording paper sheet and outputting the recording paper sheet. The image forming apparatus 10 includes a system controller 11 for controlling the working of whole system and a processor 12 for playing a role of a computation process function, which are connected each other.

The system controller 11 is further connected with a system memory 13, a nonvolatile memory controller 30 as a data save apparatus, a power watch section 14, a scanner section 15, a printer section 16 and an operation display section 17. The system memory 13 is a volatile memory, which is commonly used for storing a program to be used by the processor 12, for a work memory when the processor 12 executes a program, and for storing image data.

The power watch section 14 watches the power, which has been supplied to the image forming apparatus 10, and plays a role for outputting a power interruption detection signal TS when having detected that the power starts turning off. Here, the power watch section 14 is configured to output the power interruption detection signal TS, when convert alternate voltage supplied as power source from outside is converted into direct voltage by using a rectifier circuit (not shown) and the converted direct voltage has dropped equal to or less than a prescribed threshold voltage. The output state of the power interruption detection signal TS is transmitted to the processor 12 through the system controller 11.

A nonvolatile memory 18 is connected with the nonvolatile memory controller 30 under the control thereof. The nonvolatile memory 18 is a memory, in which the memorized content is held even though the power is turned off. The nonvolatile memory stores prescribed data, such as, various parameters peculiar to the apparatus and a count value of a number of sheet be copied, which need to be stored after power has been turned off. The nonvolatile memory controller 30 is a circuit for controlling a data read/write function from/to the nonvolatile memory 18, the detail of which will be described later.

The scanner section 15 includes a light source for exposing a document, a line image sensor for reading out by one line of the document in a width direction, a moving mechanism for moving a reading position by one line unit in a longitudinal direction of the document and optical parts configured by a lens and a mirror for guiding reflected light from the document to the line image sensor for focusing images thereon. The line image sensor is configured by a CCD (Charge Coupled Device) image sensor. Further, the scanner section 15 includes an A/D converter for converting analog image signal outputted from the line image sensor to digital data. Further, the scanner section 15 includes an automatic document feeder (not shown) for sequentially and continuously reading a plurality of documents.

The printer section 16 is an apparatus for forming the image corresponding to an inputted image data onto a recording paper sheet by an electro photographic process and outputting it. The printer section 16 includes a conveyance apparatus of recording paper sheets, a photosensitive drum, a charging apparatus, a laser unit, a developing apparatus, a transfer-separator apparatus, a cleaning apparatus, a fixing apparatus and a controller for controlling these apparatuses (which are not illustrated) described above. The printer section 16 is configured as, what is called, a laser beam printer.

The operation display section 17 is arranged to receive various operations from a user and to display various operational screens and guiding screens. The operation display section 17 is configured by a liquid crystal display, a touch panel, operational switches and a CPU used for control thereof.

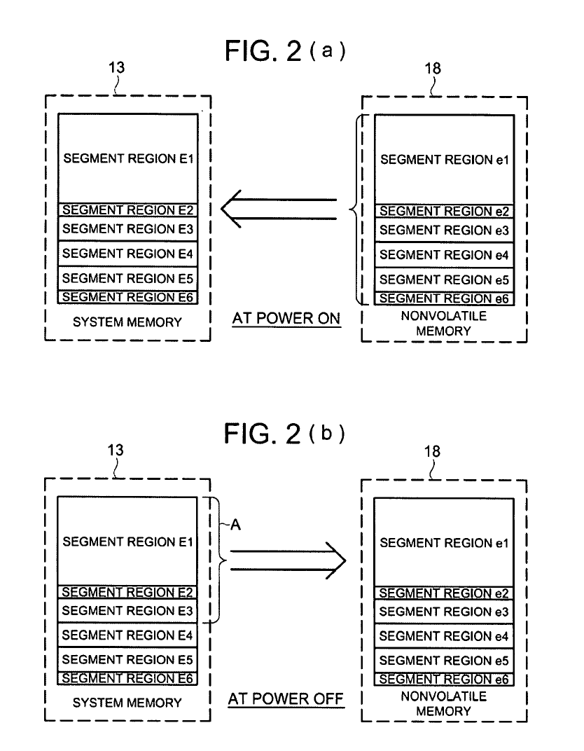

The image forming apparatus 10 is arranged so that the processor 12 reads out the data in the nonvolatile 18 when the power is turned on and expands them onto the system memory 13 as shown in FIG. 2(a). After that, instead of accessing the data in the nonvolatile memory 18, the processor 12 accesses the data expanded on the system memory 13.

The region in the nonvolatile memory 18 and the region in the system memory 13, to which the data from the nonvolatile memory 18 is expanded, are controlled by respectively divided into a plurality of segment regions E1-E6 having uneven capacity. In case that the total capacity of the segment regions E1-E6 is to be 100%, the segment region E1 is set at 40%; the segment region E2 is set at 5%; the segment region E3 is set at 15%; the segment region E4 is set at 25%; the segment region E5 is set at 10%; and the segment region E6 is set at 5%. Here, the setting percentages of respective segment regions to the total capacity are examples and it is apparent the other percentages may be possible.

When the power is turned on, all segment regions E1-E6 in the nonvolatile memory 18 are expanded onto the system memory 13. The data expanded onto the system memory 13 from the nonvolatile memory 18 is referred or rewritten by the processor 12 in response to the operation of the image forming apparatus 10.

When the power is turned off, data save from the system memory 13 to the nonvolatile memory 18 will be conducted. In reality, the data save needs to be completed within a limited period (it will be called an extension time), which corresponds to a time period from the time when the power watch section 14 outputs the power interruption detection signal TS to the time when the output voltage of a DC power source (not shown) falls down and reset signal is outputted. Here, as illustrated in FIG. 2(b), the data amount A, which can be saved within the extension time period, is 50% of total capacity of the segment regions E1-E6 with some allowances.

As a result of that the processor 12 has rewritten the data in the system memory 13 on the process of conducting a copy operation, the total capacity of the segment regions, the data of which has been updated, in the segment regions E1-E6 in the system memory 13 becomes more than a prescribed value (for example, 50% of the capacity of total segment regions), the nonvolatile memory controller 30 transfers and saves the memory contents of the segment regions, in which data has been updated in the segment regions E1-E6 in the system memory 13. By successively executing the save process, the total capacity of the segment regions, in which data has not been saved into the nonvolatile memory, in the system memory 13 is always controlled so as to be equal to or less than data amount A, which can be saved within the extension time when power is tuned off.

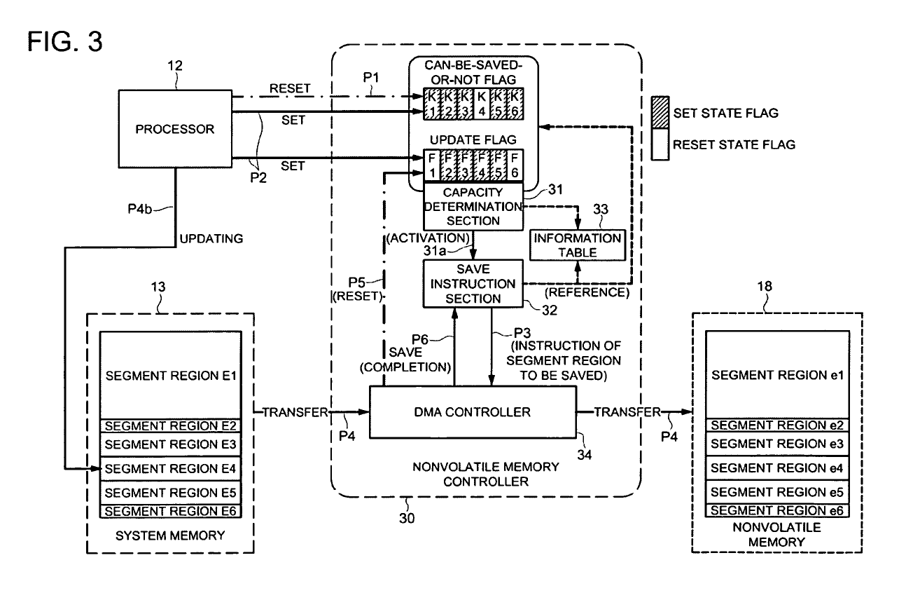

FIG. 3 illustrates an inside configuration of the nonvolatile memory controller 30. The nonvolatile memory controller 30 is configured as an ASIC (Application Specific Integrated Circuit). The nonvolatile memory controller 30 includes update flags F1-F6 provided for corresponding to respective segment regions E1-E6 with one to one relation (corresponding to the one having the same number added to the alphabetic character), can-be-saved-or-not flags K1-K6 provided corresponding to respective segment regions E1-E6 with one to one relation (corresponding to the one having the same number added to the alphabetic character), a capacity determination section 31, a save instruction section 32, an information table 33 and a DMA controller 34.

The update flags F1-F6 are flags for showing whether corresponding segment regions E1-E6 have been updated. “1” denotes that update has been conducted, “0” denotes that update has not been conducted. The can-be-saved-or-not flags K1-K6 are flags showing whether corresponding segment regions E1-E6 are in a situation where data save are ready. “1” denotes that data save is ready, “0” denotes that data save is not ready. For example, in case when the processor 12 is in a state where updating a certain segment region En (“n” can be an arbitrary integer from 1 to 6), the corresponding can-be-saved-or-not flag Kn is reset to “0”.

The identification numbers and capacity information of respective segment regions E1-E6 have been correlated and registered into the information table 33. In an embodiment of the present invention, the capacity information indicates the capacities of respective segment regions E1-E6 by the percentages against the total capacity.

The address information indicating the positions of segment regions E1-E6 in the system memory 13 is also registered into the information table 33. This information has been memorized in the ROM (Read Only Memory) (not shown). The processor 12 is arranged to read out the information from the ROM and register the information into the information table of the nonvolatile memory controller 30 when power is turned on. In the case when configuring the segment regions E1-E6 in such a way as that the capacity thereof can be changed, the information contents to be registered into the information table 33 will change. In this case, by ensuring that the information to be registered into the information table 33 is stored in the top portion of the segment region E1 in the nonvolatile memory 18, for example, the processor 12 is able to read out necessary information from the region of the nonvolatile memory 18 and set the information into the information table 33 when power is turned on.

The capacity determination section 31 calculates the total capacity of the segment regions, to which the update flags have been set, based on the status of the update flags F1-F6 and the capacity information of respective segment regions E1-E6 registered in the information table 33, and determines whether the total capacity of calculation result reaches to the prescribed value. In case when the total capacity has reached to the prescribed value, the capacity determination section 31 outputs activation signal 31a to a save instruction section 32. Here, the capacity determination section 31 obtains the total capacity by the calculation based on the following formula (I).

Total capacity=capacity information of segment region E1×value of update flag F1+capacity information of segment region E2×value of update flag F2+capacity information of segment region E3×value of update flag F3+capacity information of segment region E4×value of update flag F4+capacity information of segment region E5×value of update flag F5+capacity information of segment region E6×value of update flag F6. (1)

The save instruction section 32 detects and determines whether the data need to be saved into the nonvolatile memory 18 of respective segment regions E1-E6 from the update flags F1-F6 and the can-be-saved-or-not flags K1-K6. Further, the save instruction section 32 recognizes the capacities of respective segment regions E1-E6 by referring to the information table 33, judges the data save order, then, select the segment region En, which should be saved into the nonvolatile memory 18, and plays a role to output a transfer instruction of the selected segment region En to the DMA controller 34.

Once the DMA controller 34 has transferred one segment region En from the system memory 13 to the nonvolatile memory 18 according to the transfer instruction from the save instruction section 32, the DMA controller 34 rests the update flag Fn corresponding to the segment region En, the data transfer of which has been completed. The nonvolatile memory controller 30 includes a stopped bit (not shown) provided for corresponding to respective segment regions E1-E6 with one to one relation. The stopped bit is used to control stopping transfer of the data, which is under DAM transfer.

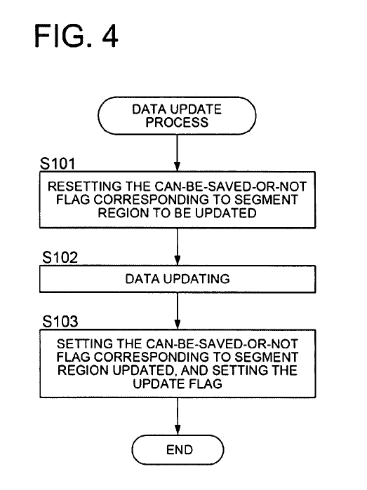

FIG. 4 illustrates a flow of a data update process, in which the processor 12 rewrites and updates data in any one of segment regions En. The processor 12 rests the can-be-saved-or-not flag Kn corresponding to the segment region En, the data of which is to be updated, (step S101, FIG. 3: P1) and updates the data corresponding to the segment region En (step S102). After having completed the data update, the processor 12 sets the can-be-saved-or-not flag Kn and the update flag Fn corresponding to the segment region En, the data of which has been updated (step S103, FIG. 3: P2).

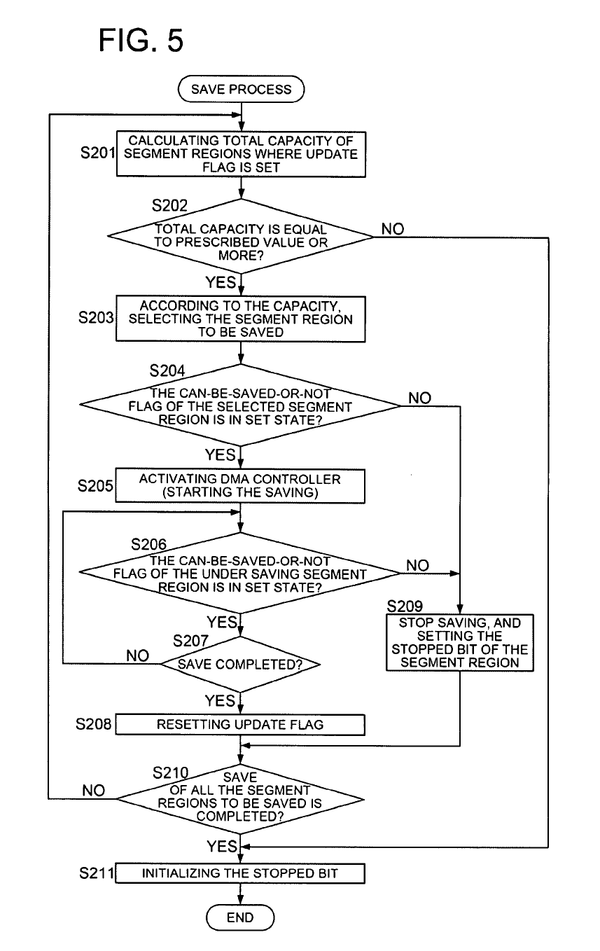

Next, the operation of the nonvolatile memory controller 30 will be described by referring to FIGS. 5 and 3.

FIG. 5 illustrates the data flow of the data save process executed by the nonvolatile memory controller 30. The process illustrated in FIG. 5 operates when the processor 12 updates the data in any one of segment regions En (FIG. 3; P1 and P2) and sets the update flag Fn, which corresponds to the segment region En. The nonvolatile memory controller 30 configured as an ASIC executes the process illustrated in FIG. 5 based on a installed micro program.

The capacity determination section 31 calculates the total capacity of the segment region where the update flag F has been set, by using the foregoing formula (I) (step S201), and determines whether the total capacity reaches to the prescribed value (step S202). In case when the total capacity has not reached to the prescribed value (step S202: NO), the stopped bit is initialized (step S211) and the process will be completed (END). On the other hand, in case when the total capacity has reached to the prescribed value (step S202: YES), the capacity determination section 31 outputs the activate signal 31a to the save instruction section 32.

When the save instruction section 32 receives the activate signal 31a from the capacity determination section 31, the save instruction section 32 selects the segment region En to be saved next to the nonvolatile memory 18 in the segment regions, in which the stopped bit has not been set and the update flag has been set, based on the capacity of the segment region (step S203). In the selection based on the capacity, there are large capacity priority selection for selecting one having a large capacity, and small capacity priority selection for selecting one having a small capacity. The selection method should have been determined in advance and the setting should have been completed. The save instruction section 32 select the method according to the setting.

The save instruction section 32 refers to the can-be-saved-or-not flag Kn corresponding to the selected segment region En. In case when the can-be-saved-or-not flag Kn has been set (step S204: Yes), the save instruction section 32 instructs the DMA controller 34 to activates the transmission so as to conduct DMA transfer of the selected segment region from the system memory 13 to the nonvolatile memory 18 (step S205, FIG. 3: P3).

While the DMA controller 34 is conducting DMA transfer (FIG. 3: P4) for saving data, the save instruction section 32 monitors whether the can-be-saved-or-not flag Kn corresponding to the segment region En, where the data is under the save process, is in a set state. In case when having completed the saving operation of the segment region En without reset of the can-be-saved-or-not flag Kn (step S207: Yes), the DMA controller 34 resets the update flag Fn corresponding to the segment region En, where the data has been saved (step S208, FIG. 3: P5), and at the same time, notifies the save instruction section 32 of the completion of the saving operation (FIG. 3: P6). After that, the save instruction section 32 detects whether the save of all the segment regions to be saved have been completed. In case when the save of the segment regions to be saved has been completed (step S210: Yes), the save instruction section 32 initializes (rests) the stopped bit and the process will complete (End).

In case when the save of the segment regions to be saved has not been completed (step S210: No), the process flow returns step S201 and continues the process. However, in case when the total capacity of the segment regions to be saved becomes equal to or less than prescribed value (step S202: No), the save instruction section 32 initialize the stopped bit (step S211) and completes the process (End).

In order to determine whether the save has been completed, the update flags F1-F6 are used. In case when all the update flags F1-F6 have been reset, it is determined that the save of all segment regions to be saved has been completed.

In case when the can-be-saved-or-not flag Kn corresponding to the segment region En, which is under the data save process by the DMA controller 34 (FIG. 3: P4), is reset (step S206: No, FIG. 3: P1), the data save process for the segment region En is stopped and the stopped bit (not shown) corresponding to the segment region En is set (step S209). Namely, since the processor 12 restarts the data update process against the segment region En, where the update flag has been set (FIG. 3: P4b), the data transfer related to the segment region En is immediately stopped to avoid the access conflict between the access of the processor 12 to the segment region En and the DMA controller 34. Further, the useless saving operation pertaining to the segment region En, for which the processor 12 is conducting the update operation, can be prevented. In the example illustrated in FIG. 3, the data update operation is conducted for the segment region E4 and can-be-saved-or-not flag K4 has been reset.

After having stopped the data save process, the save instruction section 32 determines whether the save of the segment region to be saved has completed. In case when the save process has not been completed (step S210: No), the process returns to step S201 and continues the operation. In case when the save process has been completed (step S210: Yes), the process initializes (resets) the stopped bit and completes the process (End).

A concrete example of the foregoing process will be described. For example, the prescribed value for judging the total capacity is set to be 50% of total capacity. In case when the selection of the segment region has been to be conducted by giving priority on the large capacity segment region, and data update has been to be conducted in the order of the segment region E4 (capacity: 25%), the segment region E3 (capacity: 15%), the segment region E2 (capacity: 5%) and the segment region E5 (capacity: 10%). And it is assumed that the status of the system memory and the nonvolatile memory have becomes an aspect as illustrated in FIG. 3. In this case, the total capacity becomes 55% when the segment region E5 has been updated. Since the total capacity is more than the prescribed value 50%, the capacity determination section 31 outputs the activation signal 31a (FIG. 5, step S202: Yes).

The save instruction section 32 selects the largest capacity segment region E4 (capacity: 25%) according to the large capacity priority. However, since the segment region E4 is under the status where the processor 12 is conducting data update and the can-be-saved-or-not flag K4 corresponding to the segment region E4 has been reset, the save instruction section 32 sets the stopped bit corresponding to the segment region E4 and does not conduct the DMA transfer (step S209).

After that the process returns to step S201. Since the calculated total capacity is 55%, the save instruction section 32 selects the next largest capacity segment region E3 (capacity: 15%) (step S 203). The save instruction section 32 checks the can-be-saved-or-not flag K3 corresponding to segment region E3. Since the can-be-saved-or-not flag K3 has been set as illustrated in FIG. 3 (step S204: Yes), the save instruction section 32 determines that the saving operation is ready, transfers the contents of the segment region E3 to the nonvolatile memory 18 from the system memory 13 and instructs the DMA controller 34 to save the contents of the segment region E3 (step S205).

The DMA controller 34 executes the transfer of the segment region E3. When the transfer operation has been completed, the DMA controller 34 resets the update flag F3 corresponding to the segment region E3 (step S208). Based on this process, the status of the update flag has come to the situation where only the update flags F2, F4 and F5 are set. Thus, the process returns to step S201 to recalculate the total capacity of the segment regions E2, E4 and E5. Since the calculated result becomes 40%, which is not equal to or more than 50% (step S202: No), the DMA controller 34 initializes the stopped bit and completes the save process.

As described above, by preferentially transferring the data in the segment region having larger capacity, the margin until the total capacity reaches again to the prescribed value becomes large. And, even though the data of the segment region having small capacity has been update thereafter, it is not liable that the total capacity of the segment regions becomes more than the prescribed value. For example, in the above example, suppose the can-be-saved-or-not flag K4 has been set, and the data in the segment region E4 (capacity: 25%), which has been selected at first, has been transferred. In this case, the total capacity at the time when the transmission of the data in the segment region E4 has completed becomes 30% and the margin to the prescribed value becomes 20%. Thus, even though the data of the segment region E6 (capacity: 5%) has been updated, the total capacity of the segment regions, where the update flags have been set, does not become more than the prescribed value, and the save process to the nonvolatile memory 18 is not conducted. Based on this arrangement, the number of rewrite operations of the nonvolatile memory 18 can be reduced, which contributes the life of the nonvolatile memory 18.

Further, in case when the can-be-saved-or-not flag Kn indicates that the save process cannot be conducted, since the processor 12 stops the DMA transfer from the system memory 13 to the non volatile memory 18, the conflict between the access of the processor 12 to the segment region En and the access to the DMA controller can be avoided so that the processor 12 can smoothly proceed the process. Further, even though the processor 12 is in a situation where the processor 12 is updating a certain segment region, since the DAM controller 34 conducts DMA transfer from other segment regions, the data update process by the processor 12 and the save process by the DAM controller 34 can be conducted in parallel, which can improves the process efficiency.

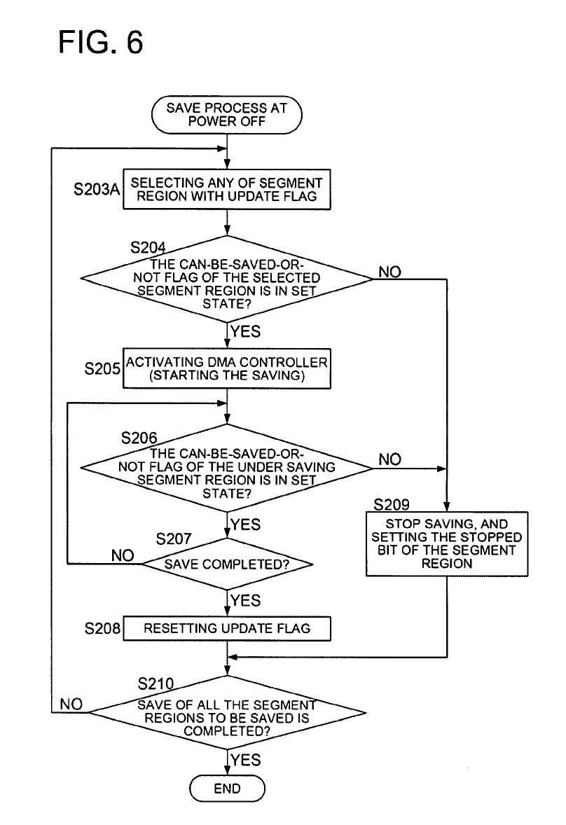

FIG. 6 illustrates the operation of the nonvolatile memory controller 30 when the power is turned off. Once the power watch section 14 outputs the power interruption detection signal TS, the processor 12 notifies the nonvolatile memory controller 30 that the power interruption has occurred. The nonvolatile memory controller 30 executes a power-off-save-process as illustrated in FIG. 6. In FIG. 6, the same step number has been put on the same process in FIG. 5 and the explanation will be appropriately omitted.

When power is turns off, the data save process is executed irrespective to the fact that the total capacity of the segment regions where the update flag has been set, has reached to the prescribed value or not. Namely, with respect to the segment region, which can be saved, to which the update flag has been set and the can-be-saved-or-not flag has also been set, the saving process to the nonvolatile memory 18 will be conducted. However, the process to set the priority order corresponding to the capacity is not conducted, and the segment region is selected based on an arbitrary order (step S203A). Data is transmitted by the DMA transfer. Further, after that, since the power is completely tuned off, the initialization of stopped bit will not be conducted. In this case, the order of the save process may be determined based on the capacity.

In a normal condition, based on the save process illustrated in FIG. 5, since the data amount to be saved when power is turned off is controlled so as to be equal to or less than the prescribed value, the data save can be completed within the extended time period from the time when the power interruption detection signal TS is outputted to the time when the reset signal is outputted.

In case when the priority is given to the segment region having a smaller capacity in the save process illustrated in FIG. 5, since the segment regions having the large capacity, which has not been save, are left, the number of segment regions to be saved when power is turned off becomes smaller comparing with the case where the segment regions having a smaller capacity are left. Thus, the number of setting and activation of DMA transfer in the save process when power is turned off decreases, time-loss caused by the setting and activation can be lowered and the data save process to the nonvolatile memory can be efficiently conducted within a limited time period. There can be a case where the prescribed value used for determining the total capacity can be further raised comparing with the case where giving the priority to the larger capacity segment region.

Embodiments of the present invention have been described by referring to the drawings. The present invention is not limited to the above embodiments and various changes and modification may be made without departing from the scope of the invention.

In this embodiment, the capacity determination section 31 is arranged to determines whether the save process is necessary by comparing the total capacity of the segment regions where the update flags have been set with a prescribed value. However, the system may be configured so that obtained is the total capacity of the segment regions where the update flags have been set and the can-be-saved-or-not flags have been set, and in case when the total capacity reaches to the prescribed value, executed is the data save process from the system memory 13 to the nonvolatile memory 18.

Further, the number of segment regions and capacity are not limited to the examples in embodiments, which may be arbitrary.

In these embodiments, the example based on the image forming apparatus 10 has been described. However, the data save apparatus (nonvolatile memory controller 30) of the present invention may be applied to an apparatus as long as the apparatus is arranged to save the data in the volatile memory to the nonvolatile memory when the power is turned off.

According to the present embodiment, the data transfer from a system memory to a nonvolatile memory is conducted by DMA (Direct Memory Access) mode in descending order of segment region capacity when the total capacity of segment regions, which need data save, reaches to a prescribed value. By deciding based on the total capacity, even the capacity of the segment regions are uneven, the capacity of the data having not been saved can be maintained equal to or less than the prescribed value. Further, by preferentially transferring the data in the segment region having larger capacity to a nonvolatile memory by DMA (Direct Memory Access) mode, the margin until the total capacity reaches again to the prescribed value becomes large, in cases where the transfer of the data with the unit of each segment regions is discontinued at the time when the total capacity of the remaining regions decreased to below the prescribed value. And, even though the data of the segment region having small capacity has been update thereafter, it is not liable that the total capacity of the segment regions becomes more than the prescribed value. According to this arrangement, the number of rewrite operations of the nonvolatile memory can be reduced, which contributes the life of the nonvolatile memory.

According to the another embodiment, the data transfer from a system memory to a nonvolatile memory is conducted by DMA (Direct Memory Access) mode in ascending order of segment region capacity when the total capacity of segment regions, which need data save, reaches to a prescribed value. By deciding based on the total capacity, even the capacity of the segment regions are uneven, the capacity of the data having not been saved can be maintained equal to or less than the prescribed value. Further, by preferentially transferring the data in the segment region having smaller capacity, the segment regions having the large capacity, which has not been save, are left, as segment regions to be saved when power is turned off. As the result, the number of segment regions to be saved when power is turned off becomes smaller comparing with the case where the segment regions having a smaller capacity are left. Thus, the number of setting and activation of DMA transfer in the save process when power is turned off decreases, time-loss caused by the setting and activation can be lowered and the data save process to the nonvolatile memory can be efficiently conducted within a limited time period.

According to the present embodiment, whether data saving of respective segment regions is required or not, is determined based on judgment of whether the segment regions has been updated, and whether data save is possible. The value of the can-be-saved-or-not flag corresponding to the segment region, into which a CPU (Central Processing Unit) is writing data, is set so as to indicate that the data save is impossible. For example, assuming that the condition for determining the data save to be necessary is a case where data has been updated and data save is possible, since the object of the DMA transfer is limited to the segment region, to which CPU is not under access, the write process of the CPU and the data save process by the DMA transfer can be executed on the other segment regions, which are not limited, in parallel.

According to the present embodiment, the total capacity is redetected every when transfer of one segment region is completed, and the DMA transfer of the data of remaining segment regions to the nonvolatile memory is discontinued when the total capacity becomes less than the prescribed value. Then, rewriting of the nonvolatile memory in more than necessary times can be avoided.

According to the present embodiment, since the total capacity of segment regions, which need data save, is always controlled not to exceed the prescribed value, at the time of powder turning off the data save can be completed.

What is claimed is:

1. A data save apparatus comprising:
a system memory, in which a plurality of segment regions having uneven capacities are provided;
a nonvolatile memory, into which data having been memorized in the system memory are saved; and
a controller which controls to save data with a unit of each of the segment regions into the nonvolatile memory from the system memory,
wherein the controller determines whether saving data of each of the segment regions into the nonvolatile memory is necessary, and when a total capacity of segment regions, data in which having been determined to be necessary to be saved, reaches to a prescribed value, the controller transfers the data of the segment regions determined to be necessary to be saved into the nonvolatile memory by a DMA (Direct Memory Access) mode in descending order of segment region capacity.

2. A data save apparatus comprising:
a system memory, in which a plurality of segment regions having uneven capacities are provided;
a nonvolatile memory, into which data having been memorized in the system memory are saved; and
a controller which controls to save data with a unit of each of the segment regions into the nonvolatile memory from the system memory,
wherein the controller determines whether saving data of each of the segment regions into the nonvolatile memory is necessary, and when a total capacity of segment regions, data in which having been determined to be necessary to be saved, reaches to a prescribed value, the controller transfers the data of the segment regions determined to be necessary to be saved into the nonvolatile memory by a DMA (Direct Memory Access) mode in ascending order of segment region capacity.

3. The data save apparatus of claim 1, further comprising for each of the segment regions:
an update flag which indicates whether data in each of the segment regions have been updated; and
a can-be-saved-or-not flag which indicates whether saving data in each of the segment regions is possible;
wherein the controller determines whether saving data of each of the segment regions into the nonvolatile memory is necessary, based on a state of the update flag and a state of the can-be-saved-or-not flag.

4. The data save apparatus of claim 2, further comprising for each of the segment regions:
an update flag which indicates whether data in each of the segment regions have been updated; and
a can-be-saved-or-not flag which indicates whether saving data in each of the segment regions is possible;
wherein the controller determines whether saving data of each of the segment regions into the nonvolatile memory is necessary, based on a state of the update flag and a state of the can-be-saved-or-not flag.

5. The data save apparatus of claim 1, wherein when the total capacity of the segment regions, the data in which are to be saved, becomes equal to or less than the prescribed value, the controller discontinues DMA transfer of data in remaining segment regions.

6. The data save apparatus of claim 2, wherein when the total capacity of the segment regions, the data in which are to be saved, becomes equal to or less than the prescribed value, the controller discontinues DMA transfer of data in remaining segment regions.

7. The data save apparatus of claim 1, wherein when a power source is turned off, the controller transfers data in all segment regions, data in which are necessary to be saved, into the nonvolatile memory by DMA mode.

8. The data save apparatus of claim 2, wherein when a power source is turned off, the controller transfers data in all segment regions, data in which are necessary to be saved, into the nonvolatile memory by DMA mode.

9. A data save method for saving data from a system memory, which includes a plurality of segment regions having uneven capacities, into a nonvolatile memory, with a unit of each of the segment regions, the method comprising:
determining whether saving data of each of the segment regions into the nonvolatile memory is necessary; and
transferring the data of the segment regions determined to be necessary to be saved into the nonvolatile memory by a DMA (Direct Memory Access) mode in descending order of segment region capacity, when a total capacity of segment regions, data in which having been determined to be necessary to be saved, reaches to a prescribed value.

10. A data save method for saving data from a system memory, which includes a plurality of segment regions having uneven capacities, into a nonvolatile memory, with a unit of each of the segment regions, the method comprising:
determining whether saving data of each of the segment regions into the nonvolatile memory is necessary; and
transferring the data of the segment regions determined to be necessary to be saved into the nonvolatile memory by a DMA (Direct Memory Access) mode in ascending order of segment region capacity, when a total capacity of segment regions, data in which having been determined to be necessary to be saved, reaches to a prescribed value.

11. The data save method of claim 9, wherein for each of the segment regions provided are, an update flag which indicates whether data in each of the segment regions have been updated and a can-be-saved-or-not flag which indicates whether saving data in each of the segment regions is possible,
wherein the save method further comprises the step of determining whether saving data of each of the segment regions into the nonvolatile memory is necessary, based on a state of the update flag and a state of the can-be-saved-or-not flag.

12. The data save method of claim 10, wherein for each of the segment regions provided are, an update flag which indicates whether data in each of the segment regions have been updated and a can-be-saved-or-not flag which indicates whether saving data in each of the segment regions is possible,
wherein the save method further comprises the step of determining whether saving data of each of the segment regions into the nonvolatile memory is necessary, based on a state of the update flag and a state of the can-be-saved-or-not flag.

13. The data save method of claim 9, wherein the save method further comprises the step of discontinuing DMA transfer of data in remaining segment regions, when the total capacity of the segment regions, the data in which are to be saved, becomes equal to or less than the prescribed value.

14. The data save method of claim 10, wherein the save method further comprises the step of discontinuing DMA transfer of data in remaining segment regions, when the total capacity of the segment regions, the data in which are to be saved, becomes equal to or less than the prescribed value.

15. The data save method of claim 9, wherein the save method further comprises the step of transferring data in all the segment regions, data in which are necessary to be saved, into the nonvolatile memory by DMA mode, when a power source is turned off.

16. The data save method of claim 10, wherein the save method further comprises the step of transferring data in all the segment regions, data in which are necessary to be saved, into the nonvolatile memory by DMA mode, when a power source is turned off.
